(19) United States
(12) Patent Application Publication
(10) Pub. No.: US 2024/0015045 A1
(43) Pub. Date: Jan. 11, 2024

(54) TOUCH SCREEN CONTROLLED SMART APPLIANCE AND COMMUNICATION NETWORK

(71) Applicant: Paulmicheal Lee King, Kansas City, KS (US)

(72) Inventor: Paulmicheal Lee King, Kansas City, KS (US)

(21) Appl. No.: 18/219,361

(22) Filed: Jul. 7, 2023

Related U.S. Application Data
(60) Provisional application No. 63/358,911, filed on Jul. 7, 2022.

(51) Int. Cl. H04L 12/28; H04L 67/306

(52) U.S. Cl. CPC H04L 12/282; H04L 67/306; H04L 67/12

(57) ABSTRACT

A smart appliance and communication network includes a smart stove/oven having a touchscreen flat-panel display as a user interface with a plurality of software applications that are configured, such as via programming, for data communication with other cooking appliances on a local network level and with an appliance network that enables sharing of recipes and other food data amongst network participants. The stove/oven may include a camera, a display screen, a keyboard, a speaker, a microphone, and other electronic features intended to enhance a family dynamic and food preparation experience. The smart appliance may include an artificial intelligence and machine learning interface capable of obtaining food and menu preparation that correlates with in a nutritional guideline previously entered by a user.

### REFERENCE TO RELATED APPLICATIONS

This application claims the benefit of provisional patent application No. 63/358,911 filed Jul. 7, 2022 and titled TOUCH SCREEN CONTROLLED OVEN/STOVE AND COMMUNICATION NETWORK, which is incorporated herein in its entirety.

### BACKGROUND OF THE INVENTION

This invention relates generally to smart appliances and, more particularly to a touchscreen-controlled oven/stove having a flat display panel and being connected to a wide area network that enables a family to monitor children, the elderly, monthly expenses, and to prepare recipes and nutrition-specific menus.

The kitchen is the main focal point of the modern home where families and friends gather to record cooking memories and where major decision are made for the safety of the family's future. The focus in the kitchen is the stove where recipes are gathered and handed down from family to family. The focus was to minimalize the space in the kitchen to gather the proper skills needed to maintain a healthy family lifestyle and to further maintain family and health. The present invention was designed to minimalize and maximize the cooking area in the family home to ensure that there is consistency in the family circle. This was to make sure that there is little waste in family shopping and cooking habits. The stove design was designed to further enhance the family dynamics as a way of bringing the modern family together. As it says in the Bible, “In the beginning God created heaven and earth,” so it is with inventions for the modern family to maximize the family circle. The stove design is to enhance the created thought of family and friends and to further enhance the family experience. As a family grows the appliance will grow with the family. This is to further educate the family with communication boards as a modern-day babysitter.

Therefore, it is desirable to have a touch-screen stove/oven coupled to a wide area computer network that enables a family to monitor the family dynamics including a type of intelligent latch key kid system as well as for the elderly. The stove design system will help ensure that there is more control on monthly expenses as well as enabling oversight of cooking, recipes, and even user-specific nutritional requirements.

### SUMMARY OF THE INVENTION

A smart stove according to the present invention provides the tools for a family living in a modern-day smart home for managing food preparation and family dynamics. Preferably, the smartest of becomes the central hub around which a family prepares food as well as managing chores, finances, and generally bonding in conversation and life events. In an aspect, the smart stove may include a processor and a memory for storing programming, passwords, and other user-specific data. Further, the smart stove may include a touch screen input module and a digital display by which a user may interact with the stove and recipes, menu preparation instructions, and family events may be published, respectively. The processor may be in data connection with a wireless data connection so that food and family information may be shared amongst the family's electronic devices. Still further, the processor may be in data connection with the Internet such that the smart stove is capable of communicating with other smart appliances that may be remotely connected to the Internet or another network.

An important aspect of the present invention is the smart stove's ability to track the presence of children in proximity to the stove or being connected to the local network. This feature recognizes the reality of so-called “latch-key” kids. Specifically, children may come home from school to an empty house in that the child's parents may still be at work for a period of time. Obviously, a parent is very interested and reassured to know when their children have safely returned home after school and before the parents return home. Accordingly, the smart stove may include a camera or a body sensor that is capable of taking a photograph or video that is accessible to the parent from a remote location and at a predetermined time, whereby a child's presence may be coordinated and verified.

Another important aspect of the present invention is that the smart stove has physical features that are beneficial to a family. For example, the smart stove may include multiple cameras for monitoring the cooking or baking of a recipe, including a thermometer or heat-probe, a scale, a waterspout, USB ports, electrical receptacles, and other features that will be described later. Further, individual users within the family may access the smart stove via entry of a password and may similarly enter user profile data, including nutritional or dietary guidelines or requirements that they must follow to maintain good health. A critical aspect of the present invention is that the programming or mobile application of the smart stove 10 may include an artificial intelligence and machine learning engine that is configured to access well-established nutritional and dietary databases, surveys, guidelines, and even healthy recipes available from other smart stoves and to use this information to create healthy menus and recipe data that is correlated and made specific to the user's profile data.

Therefore, it would be desirable to have a smart appliance such as a stove/oven that is operatively in data communication with a network and controlled by a software application running on the appliance display screen itself.

Another object of the present invention is to provide a smart stove/oven that is configured to communicate with other networked appliances, chefs, recipe databases, and the like so as to enhance a cooking experience.

A further object is to have a smart stove/oven that includes one or more cameras and speakers that also enhance a family cooking experience.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a smart appliance according to a preferred embodiment of the present invention;

FIG. 2a is another front perspective view of the smart appliance as an FIG. 1:

FIG. 2b is an isolated view on an enlarged scale taken from FIG. 2;

FIG. 2c is an isolated view on an enlarged scale taken from FIG. 2;

FIG. 2d is an isolated view on an enlarged scale taken from FIG. 2;

FIG. 3a is a front perspective view of the smart appliance as in FIG. 1, illustrated with the oven door in an open configuration;

FIG. 3b is an isolated view on an enlarged scale taken from FIG. 3a;

FIG. 4a is a perspective view from a lower angle of the smart appliance as in FIG. 3a;

FIG. 4b is an isolated view on an enlarged scale taken from FIG. 4a;

FIG. 5 is a rear perspective view of the smart appliance as in FIG. 1;

FIG. 6 is a block diagram illustrating the electronic components of the present system;

FIG. 7 is a block diagram illustrating the network connections related to the present invention; and

FIG. 8 is a flowchart illustrating the steps by which an AI/ML engine is utilized to correlate user-supplied nutritional considerations with respect of recipes or nutritional data.

### DESCRIPTION OF THE PREFERRED EMBODIMENT

The present invention relates to a smart appliance and communication network configured for communicating with another appliance with the same communication network and so on. An appliance may further communicate with a computer system that will connect via the communication network for a desired recipe to be fulfilled as a domestic communication network.

The primary aspect of the present invention is the smart appliance and, more particularly, a smart stove that includes many electronic assemblies and controls that provide the structures and functions described below. (References to the smart appliance and smart stove will intentionally use the same reference character 10). Specifically, the smart appliance 10 includes at least a processor 12 and a non-volatile memory 13 in data communication with the processor 12 and that is capable of storing instructions (i.e., programming 102) to be executed by the processor 12 as well as user data, food and beverage data, common nutritional data, and food preparation instructions that are correlated to individual user profile data 13b or selected family recipes. The processor 12 may be electrically connected to a router or similar data connection that enables the smart appliance 10 to communicate with other local cooking appliances such as a microwave oven and other wireless devices 10b (both of which will be referenced by reference character 10b) that are generally used for cooking or preparing food or beverages within a typical wireless home network, thus enabling members within a family or residence to access the many features of the smart appliance 10 as described below. In addition, the smart appliance 10 may include a data connection to a wide area network such as the Internet 100 and, as a result, is configured to communicate with other smart appliances 11 and various national nutritional databases 106 as will be described later in more detail.

For example, a domestic appliance may communicate via a communication network from one to another network as a type of domestic cooking option to international cooking networks via the communication network, adding further application to the domestic application provided by the communication network used to operate the domestic application. This is to ensure that the communication between the two networks is secure for the cooking application. There is a cooking encyclopedia as further communication to the domestic and international cooking networks via networks as a controlled network, so that it can be updated securely from one network to another. In other words, access to international cooking books, recipes, resources, and the like is possible directly from the smart stove 10 itself and such that traditional books or access via a separate computing device is no longer necessary. Specifically, the smart stove 10 may include a touchscreen input module 15 that may display user input boxes, include a keypad, or a keyboard 16 as would be expected using a modern smart phone, tablet, or electronic device being controlled by a graphic user interface (GUI) in cooperation with a modern operating system. In some embodiments, a traditional keyboard 16 may be in data communication with the smart stove 10 via a wired or wirelessly and will be considered an auxiliary input module.

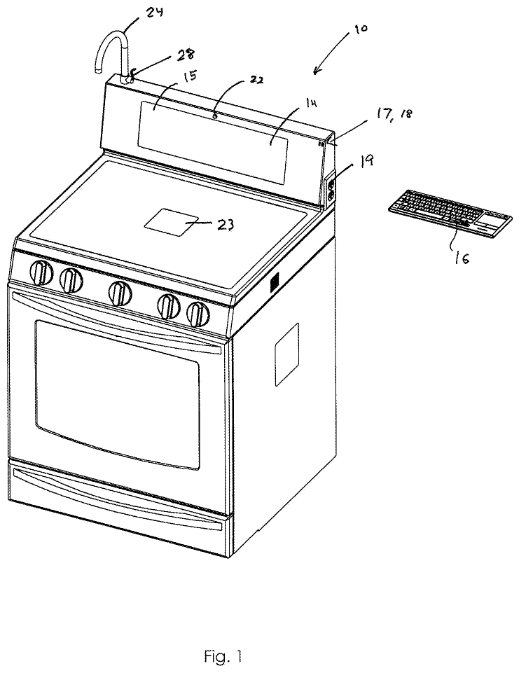

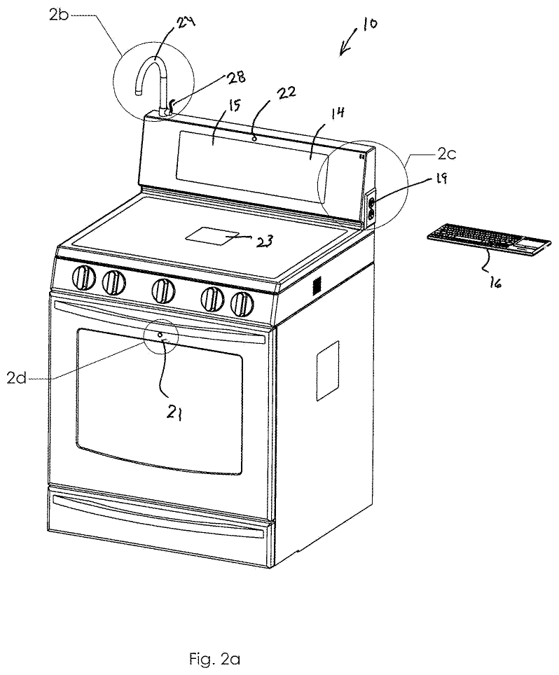

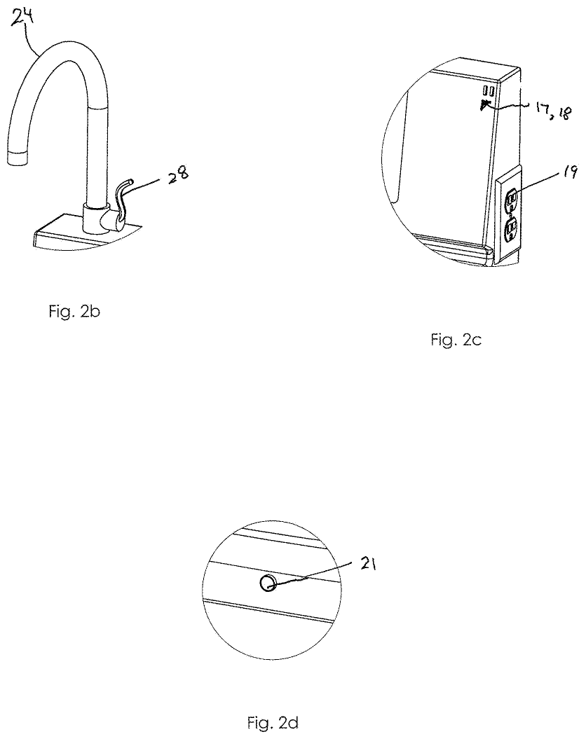

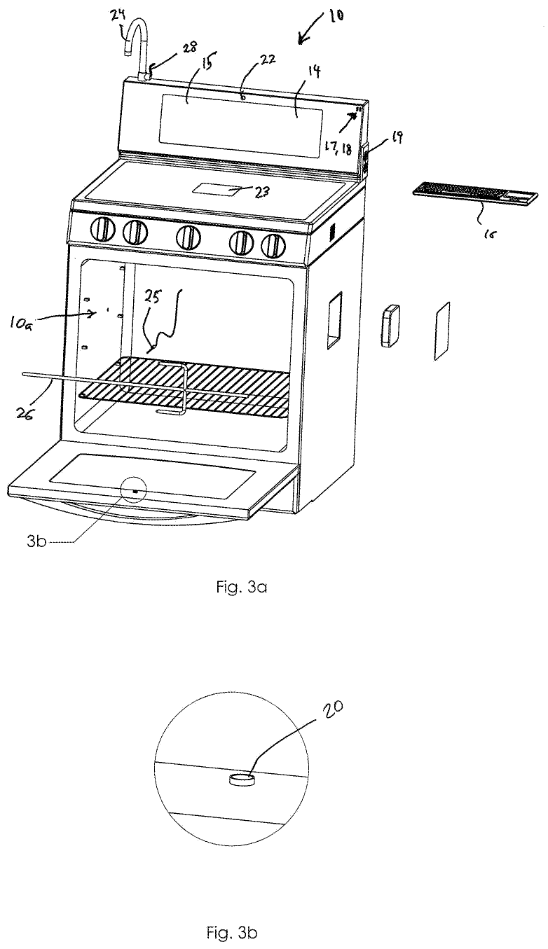

A customized cooking application (software) controls the oven. The cooking touch screen surface houses customized cooking applications and maintains the proper recall of all surface cooking techniques within those applications. Within the main cooking surface spanning the width of the main cooking surface on the very top surface of the touch screen stove, there are several main cooking surfaces that are temperature-controlled to a touch screen sensor within the touch screen surface panel display. There are buttons within the layers of the touch screen technology on a computer board that includes a cooking and controlling application as well as a temperature gauge 25 (which may also be referred to as a thermometer or temperature-probe) for temped items on the stoves surface to control the recipe temperature. Running as a controlled version of a type of operating system that will further control the applications on the main surface of the touch screen display panel that are located on the stoves main cooking surface. Specifically, a display 14 (also referred to as a display screen) may be in data communication with the processor 12 and is configured to publish recipes, user data, food preparation instructions, nutritional guidance, and the like as may be described below in more detail. Similar to smart phones, a single display device may be programmed to revert or switch between more than one mode, e.g., the display device may be used as an input/touchscreen device and also as a display screen. Accordingly, reference numerals 14 and 15 are appropriately directed to a single display device in the illustrations (FIGS. 1 and 2).

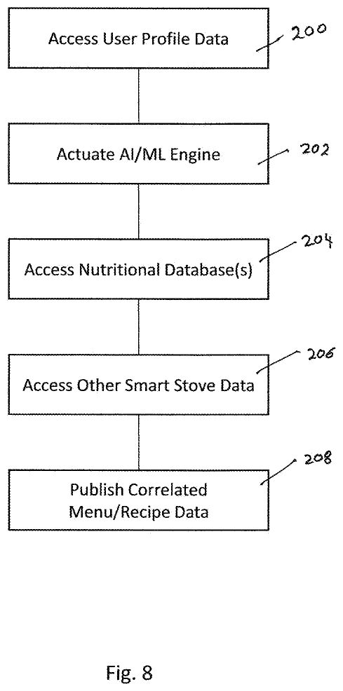

The main surface of the touch screen stove will house loading areas for password and personal loading of each cook including a return area and a home key area to recall the application selected for each user of the touch screen 15 or to further control each users personal cooking applications. The password, recipe data for each user, nutritional requirements for particular users, etc. will be referred to herein as personal profile data 13b or just user profile data 13b. To be clear, a user may be prompted to login before using the system or, if the user is new/unregistered, the new user may be prompted for password information as well as for specific dietary or nutritional requirements. For example, the user may require a diet that is free from gluten or that regulates salt or sugar quantities. As will be described later, the mobile application and/or the processor/memory combination may include or be connected to an artificial intelligence engine 102a that is configured to obtain (such as via the Internet) dietary or nutritional data specifically “correlated” to a user's dietary profile and even to modify a user-selected recipe to meet those dietary guidelines. The term “correlated” shall mean “based upon” or “related to” or “with specific reference to” or the like. Stated another way, the artificial intelligence engine 102a may be configured to determine menu selections, good preparation procedures, and recipe modifications that are adjusted or completely formed based upon the user profile data 13b input and stored by a specific user of the smart stove 10. To accomplish this, the artificial intelligence engine 102a may be trained using nutritional databases and thousands of recipe records and the like. A flowchart visually illustrating this logic is shown in FIG. 8.

In a specific embodiment, the smart stove 10 may include a thermometer 25 or equivalent temperature sensor. The application will assist the oven user to provide other information from one application to another application to further send alerts to the user that items being used have been cooked to the desired temperature. The application allows the other user to download other software applications to send food videos, access other like cooks on the same cooking system, as well as to send mail through to perform other actions that will be able to fulfill other cooking recipes on the main surface of the touch screen stove 10. This will allow the upper microwave and other like appliances to communicate with the chosen recipe on the main surface of the display 14 to the recipes that are being cooked within the same time schedule to further ensure that the cooking of items in the recipe are being cooked at the same time.

The main surface will allow cooking operation for each user's password and a picture of themselves as to the one operating the functions on the stove when the desired application is installed for family safety as to what was last cooked that is stored on the main stove panel surface. There may be a recording that will allow the user to further vocalize the other options available on the touch screen stove surface. To further allow the operation for the user that will further explain the desired recipe by the user as a guide to safe cooking on the same cooking system, there are a set of speakers 27 located in the back upper surface on the reverse side cooking surface that are secure within the circuit board on the main surface that will further allow the user to hear the recipes audibly as they are being used by each user.

As described above, the software application 40 (which may include the programming executed by the processor) may include an artificial intelligence engine 102a that is configured to compare a user's dietary profile with literally thousands of nutritional and dietary data points so as to determine a menu appropriate for a login user or even to amend a selected recipe so as to be appropriate and correlated to the user's dietary requirements.

In the last decade, the applications of machine learning (ML) algorithms have proliferated in many areas of scientific, industrial, and medical applications. In general, modern artificial intelligence (AI) systems are able to classify with high precision very complex data. The algorithms have inspired the development of novel artificial neural network (ANN or NN) forming the basis of the field of artificial intelligence (AI). The developments have been in response to the vast amount of data, known as Big Data, which require new approaches to their processing, storage, and information extraction. Not without some limitations, AI continues to find new applications and provide fast information extraction based on algorithm embedded knowledge acquired with the use of available data in order to process newly available data: the process also known as NN training.

More particularly, the user profile data regarding dietary requirements of the user may be scanned and received into a natural language (NL) reader. In general, natural language processing (NLP) refers to using machine learning algorithms in relation to text and speech. More particularly, NLP may be used to create machine translations, document summaries, question answering, predictive typing, and the like. In the present case and illustrated in FIG. 8, user profile data regarding the respective users dietary and nutritional requirements may be accessed (step 200) or digitally transferred to a natural language file. Then, the artificial intelligence engine 102a may be actuated (step 202) and programmed to access literally thousands of records concerning nutritional and dietary data relevant to the dietary and nutritional requirements now in the natural language file, such as are available from national nutritional databases (step 204). Further, the artificial intelligence engine may access records obtained from other recipe sources and even recipes provided by other smart stove appliances 11 on the Internet 100 (step 206). Trained by this wealth of nutritional data, the search engine 102a is configured to prepare a menu for the logged in user that is correlated and appropriate to the dietary requirements that were entered as user profile data. Even further, the artificial intelligence engine 102a may be configured to amend or edit a chosen recipe to meet the user's nutritional and dietary requirements. The correlated menu and refined preparation data may be published to the display 14 or another appropriate file (step 208).

With even more particularity, the artificial intelligence and machine learning module may access the USDA National Nutrient Database for Standard Reference (SR) 106, which is the major source of food composition data in the United States and provides the foundation for most food composition databases in the public and private sectors. Further, the artificial intelligence with machine learning module may repeatedly access the National Health and Nutrition Examination Survey, which includes reviews concerning the nutrient profiles for specific foods and beverages as well as their associated portions and recipes. These reviews enable the artificial intelligence programming to determine what recipes and portions thereof meet the user profile data regarding nutritional and dietary requirements.

In another aspect, the smart stove 10 includes at least three cameras, all of which may be electrically connected to the processor which is then and data communication with the display 14. Specifically, a first camera 20 may be mounted or positioned inside the interior space of the oven portion 10a of the smart stove 10. Preferably, the first camera 20 in communication with the display 14 will enable a user to monitor the status and safety of the contents being cooked in the oven. In an embodiment, video data may be combined with temperature data from the thermometer as well as recipe data to formulate recommendations or warnings if preparation of the food item seems incorrect. It is understood that artificial intelligence data may also be used in this aspect because of its superior “predictive” qualities having been trained by thousands of similar cooking events.

The second camera 21 may be positioned on the oven door and is mounted such that it is directed away from the smart stove 10 proper and, instead, is focused outwardly in the manner of a proximity sensor so as to determine if a user is proximate the oven. As will be described later, a literal proximity sensor (also referred to as a body sensor) may be utilized in lieu of the second camera 21. In other words, the smart stove confirms if the oven is being monitored by a human and may be characterized as a safety feature. The third camera 22 may be mounted proximate the touch screen input module 15 and is configured to or display 14 and is also directed outwardly and configured to capture a picture of a barcode or QR code which may be placed within its view by a user. As discussed, the third camera 22 may be in data communication with the processor 12 which, upon executing an appropriate programming instruction, may take an appropriate action such as to access the respective website associated with the photographed code. In other words, the code may be associated with a recipe, a cooking offer, or the like

To further maintain the cooking ingredients as monitored, the ingredients may be cooked by way of an operating system to the desired temperature that will further control the recipe on the main cooking surface. There is a video link to link for I-think technology downloads to further transfer tv or video feed (such as video streaming via the Internet), while monitoring food from another room while maintaining a safe family life within the device.

The software associated with the smart appliance 10 includes parental controls 42 that may include prompts and publishes to the display 14 in coordination with the touchscreen input module 15. It is understood that parental controls essentially enable a parent to restrict or regulate the degree of functionality that a child can partake of regarding the smart stove and described herein. In other words, one group (i.e., the parents) are empowered to control the conduct of another group (i.e., the children). The central location of a stove uniquely allows a parent to list chores for each child residing in the house and to set parameters of what websites are or are not accessible using the Internet connection associated with the smart stove 10. This information may also be electronically delivered to other electronic devices using the home's wireless local network 101. In addition, the smart appliance 10 may be programmed to play dinner music to set the mood for the evening to some of your favorite classics while preparing the evening meal. This will allow the personal setting to who does what chore in the secured Wi-Fi house system does the connections to the family chores as scheduled. As the family schedule is set by the main operator (parents) the smart stuff 10 essentially acts like a latch key kid babysitter. This will allow the cooking instruction displayed on the main surface to be left up to a busy family schedule that will be fulfilled within a built in how to prepare foods recipe guide for the growing family. This is to ensure that family has a safe meeting place for food and safety each time the electronic stove is used to keep track of each user's cooking styles. This is a self-cooking oven that will allow the family to enjoy meals with or without supervision. As the family grows with the appliance, the appliance will grow with the family. There is a family tree cookbook template to keep track of family favorites during the holidays or other family old recipes that can be converted into an electronic recipe card as electronic video family card. The oven will calibrate the recipe as the family grows with the appliance the appliance will grow with the family to fulfill the same recipe that was cooked that holiday or special occasion. This is to ensure that the pairing of foods to a busy family schedule will be met to fulfill their busy modern family needs. There is also an area for overnight thawing for items purchased that need time to thaw out for the recipe called for in the recipe video as a step by step. That can be set by the stove's main surface as options on the stove to prepare the frozen item to be ready to be cooked.

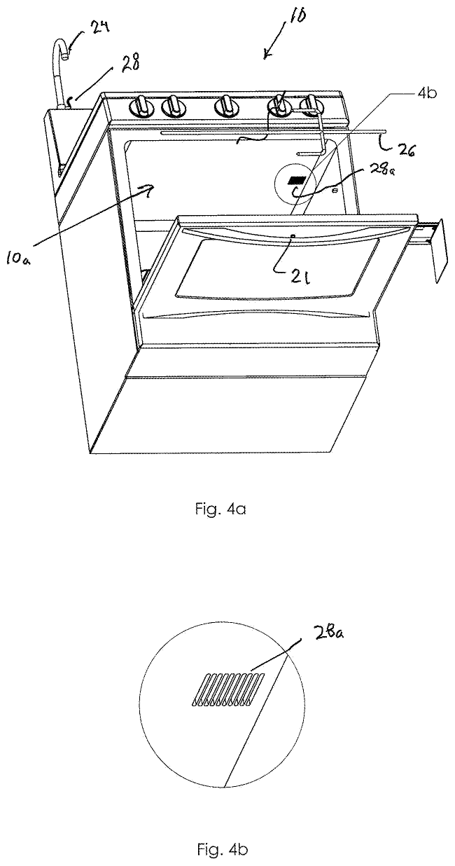

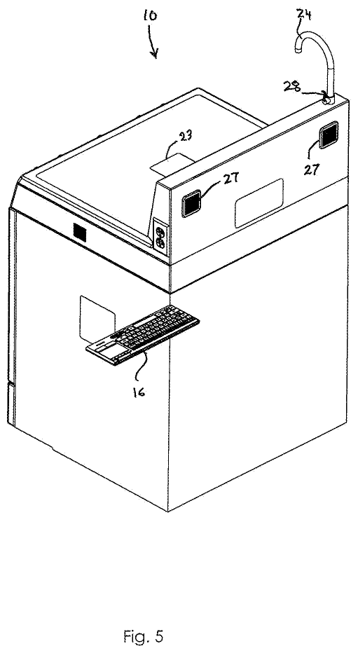

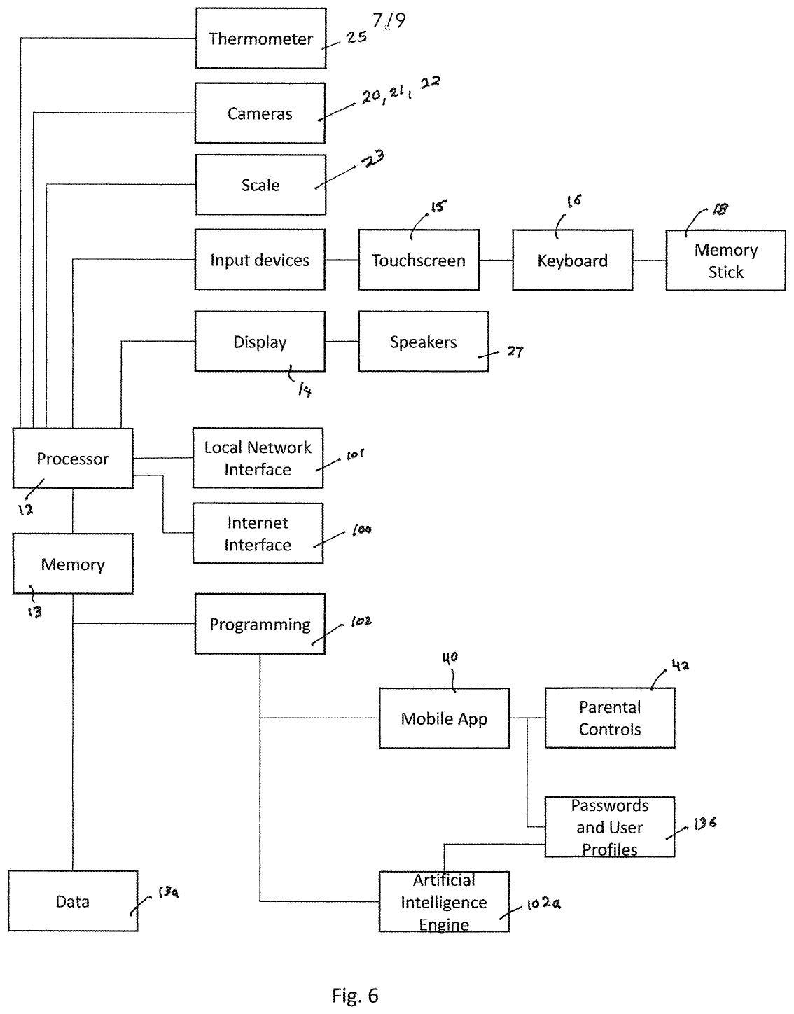

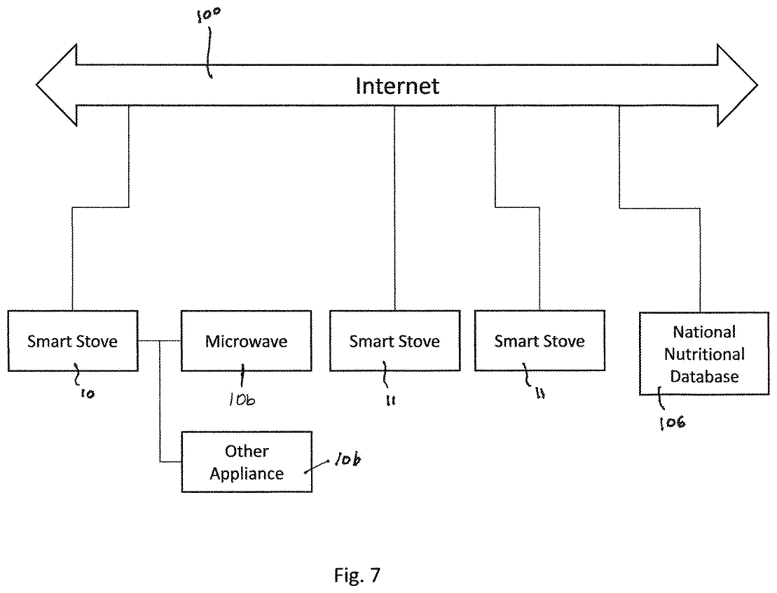

As described previously, there is a digital display 14 that may be located on the surface of the oven door that will display the main items being cooked as it thaws and is prepared within the oven wall surface. This will allow the item in the oven to be monitored as it thaws and monitored to the recipe to further allow the cooked item to be prepared for the evening meal. The screen on the surface of the stove will show the cooking temp of the item being cooked as well as the time left to cook the recipe for that item being cooked in the stove surface that is controlled by the main circuit board. There is a temperature probe (e.g., the thermometer 25) that will allow monitoring foods that are cooking the items in the stove as it is displayed on the main surface of the stove to how much time is left of the item being cooked that may be sent to a device to further ensure that the item in the recipe is to a perfect temperature as desired. This is a knob-less stove with no knobs such that there is easy clean-up of any grease on the given cooking surface. In an embodiment, the oven wall surface of the stove is covered in copper non-stick material to ensure that the cleanup is easy and the item being cooked stays to a predetermined temperature. In an embodiment, there is located within the surface of the oven a steam release inlet 28a area for receiving steam from food being cooked therein which is in fluid communication with a steam release valve 28 located atop the smart stove 10 (FIGS. 2 and 4a). The modern stove will perform the same duties of a modern microwave that will have an encased turntable within the oven rack system that will further allow the items being cooked to be rotated to further ensure the proper cooking temps of the item in the oven will have an even cooked surface by recipe as it is displayed on the displayed surface. Located on the main surface of the stove cooking surface is a food scale 23 to weigh out all ingredients to recipe located on the main surface of the cooking surface. As the recipe is being used the measurement of the items needed to weigh for meats or other ingredients are weighed out on the oven surface scale. There is a water spout 24 area beneath the surface of the main cooking surface of the stove to allow water use to be measured on the main surface by a sensor in case a recipe calls for a certain amount of water to be used. This will ensure that the recipe is kept the same when it calls for water to be used to save time as purified water system is installed for that recipe.

There is in the center of the stove a place to house a meat rotisserie 26 that is viewed and controlled by the main circuit board that will further allow the recipe that is used by the main user of the product being used to perform the proper recipe to temp that will give the proper recipe to be cooked to the recipe temperature. There is also located a sensor in the oven main area a way to monitor the item being used in the recipe as it is being rotated in the oven wall surface. That is further viewed on a display panel by the first camera 20 centered in the center of the oven door. On the surface of the oven wall are heat treated glass that will allow the proper cooking by a type of glass. The oven will self-lock to allow the proper recipe to be cooked at the proper temperature. There is also a monitor for the items being cooked to make sure that the proper cooking temperature is being maintained with the oven wall.

There is located a body sensor (described earlier as a second camera 21) that will inform the main user (parent) that there is an object in front of the oven door that will alarm the main user that there is an object in front of the cooking stove. This will inform the main user by a given device to check the cooking area as the desired recipe is completed. Located at the bottom of the oven is a warming area that can be used to keep food warm while the main food recipes are being cooked or to hold certain food temps for certain items to hold the recipe to further maintain the recipe ingredients. There is located at the top of the stove surface a power button that is located at the center of the stove. To the left and right are power utility cord receptacles 19 on each side of the stove top main surface that are cover by hidden surface caps located on the top main part of the stove. Located of the right side of the stove's main surface is located a USB port 17 (or multiple ports) as well as a place for a memory stick 18, that will allow the stoves information to be transferred to any other device. In an embodiment, there may also be a hidden cd drive to house a recording on any CD-R that will allow memory to be recorded to the left of the main side of the stoves surface. That will further allow the CD-R to transfer recorded information to any cd drive to further allow swapping of recorded information to be kept and stored in case there is a loss of recorded information, allowing what is missing to be recovered. This will ensure that the information is recorded and restored. There is also a port or USB port to type in or to recover the data to further restore missing information due to power shortage. There may also be a traditional or wireless keyboard 16 so as to manually type a lost recipe. Also included in the abstract will be a written appliance restoring doc, to reset all setting when there is electrical surge. There may be a surge protector that will maintain the usage of the power source that may enter the electronic stove to further secure the circuit board from being damage. This is to maintain the functioning of the stove's circuit board that will maintain the functioning of the stove's electrical usage. This also will relieve any mishaps that may occur with an electrical surge.

It is understood that while certain forms of this invention have been illustrated and described, it is not limited thereto except insofar as such limitations are included in the following claims and allowable functional equivalents thereof.

1. A smart appliance for managing food preparation and family dynamics within a smart home, said smart appliance comprising:
a cooking appliance that includes a cooktop having cooking burners and an oven defining an interior space, said cooking appliance having a processor and a non-volatile memory capable of storing programing, said processor being in data communication with a wireless data connection that is configured for communicating with other appliances via a local area network and being in data communication with remote smart appliances displaced along a wide area network;
a touchscreen input module mounted atop said cooking appliance that is in data communication with said processor;
a display mounted atop said cooking appliance in data communication with said processor;
wherein said cooking appliance includes a first camera in data communication with said processor positioned in said interior space of said oven and a second camera positioned on an oven door and directed outwardly and configured so as to detect the presence of a user;
wherein said cooking appliance includes a third camera in data communication with said processor and directed outwardly and configured to read a QR code or barcode when actuated;
a software application stored in said memory that, when executed by said processor, is capable of:
receiving password and personal profile data via said touch screen input module and storing said received password and personal profile data in said memory;
obtaining food menu and preparation data from said remote smart appliances and via said wide area network that is correlated with said received personal profile data; and
publishing on said display said obtained food menu and preparation data that is correlated with said received personal profile data.

2. The smart appliance as in claim 1, wherein said personal profile data includes user nutritional and dietary requirements.

3. The smart appliance as in claim 2, wherein said software application includes an artificial intelligence engine in data communication with said memory and with an official source of nutritional guidelines such that said artificial intelligence engine is trained by repeatedly downloading nutritional data updates for correlation with said user profile data, respectively.

4. The smart appliance as in claim 2, wherein said step of obtaining food menu and preparation data that is correlated with said received personal profile data includes providing a neural network (NN) in data communication with a dietary database and having algorithms configured for machine learning (ML) and artificial intelligence (AI) operable to determine said published food menu and preparation data.

5. The smart appliance as in claim 4, wherein said dietary database includes the USDA National Nutrient Database for Standard Reference (SR) and the National Health and Nutrition Examination Survey.

6. The smart appliance as in claim 5, wherein said algorithms are trained using data from said dietary database and recipe data obtained from said remote smart appliances via the Internet.

7. The smart appliance as in claim 1, wherein said cooking appliance includes a thermometer and a speaker in data communication with said processor.

8. The smart appliance as in claim 7, wherein said cooking appliance includes a water spout in fluid communication with a water source, a weight scale in data communication with said processor, and a rotisserie assembly positioned in said oven and in data communication with said processor.

9. The smart appliance as in claim 8, wherein said cooking appliance includes a USB port, a memory stick receiver, and a keyboard in data communication with said processor.

10. The smart appliance as in claim 1, wherein said software application includes parental controls enabling one group of users to determine a scope of operability of said cooking appliance by another group of users.

11. A method for managing food preparation and family dynamics using a smart appliance installed in a smart home, said method comprising:
providing a cooking appliance in said smart home that includes an oven and a cooktop and that is capable of communicating with other cooking appliances located in said smart home via a wireless local network and that is capable of communicating with remote cooking appliances via the Internet;
receiving password data and user profile data entered via a touchscreen input module positioned atop and in data communication with said cooking appliance:
monitoring a cooking event occurring within an interior area of an oven portion of said cooking appliance via a first camera positioned in said interior area;
determining if a user is physically present and proximate said oven portion of said cooking appliance via a second camera positioned proximate a door of said oven portion and directed away from said oven portion;
obtaining food menu and preparation data from said remote smart appliances and via said wide area network that is correlated with said received personal profile data; and
publishing on a digital display said obtained food menu and preparation data that is correlated with said received personal profile data.

12. The method as in claim 11, wherein said received personal profile data includes user nutritional and dietary requirements.

13. The method as in claim 12, wherein said step of obtaining food menu and preparation data that is correlated with said received personal profile data includes providing a neural network (NN) in data communication with a dietary database and having algorithms configured for machine learning (ML) and artificial intelligence (AI) operable to determine said published food menu and preparation data.

14. The method as in claim 13, wherein said dietary database includes the USDA National Nutrient Database for Standard Reference (SR) and the National Health and Nutrition Examination Survey.

15. The method as in claim 14, wherein said algorithms are trained using (1) data from said dietary database and using (2) recipe data obtained from said remote smart appliances via the Internet.

16. The method as in claim 11, further comprising reading a QR code or a barcode via a third camera mounted to and in data communication with said cooking appliance.

17. The method as in claim 11, wherein said cooking appliance includes a thermometer and a speaker in data communication with said processor.

18. The method as in claim 17, wherein said cooking appliance includes a water spout in fluid communication with a water source, a weight scale in data communication with said processor, and a rotisserie assembly in data communication with said processor.

19. The method as in claim 18, wherein said cooking appliance includes a USB port, a memory stick receiver, and a keyboard in data communication with said processor.

20. The method as in claim 11, wherein said software application includes parental controls enabling one group of users to determine a scope of operability of said cooking appliance by another group of users.
